(19) United States
(12) Patent Application Publication
(10) Pub. No.: US 2024/0237733 A1
(43) Pub. Date: Jul. 18, 2024

(54) VAPORIZER AND AEROSOL-GENERATING DEVICE INCLUDING THE SAME

(71) Applicant: KT&G CORPORATION, Daejeon (KR)

(72) Inventor: Tae Hun KIM, Yongin-si, Gyeonggi-do (KR)

(73) Assignee: KT&G CORPORATION, Daejeon (KR)

(21) Appl. No.: 18/289,336

(22) PCT Filed: Jun. 16, 2022
(86) PCT No.: PCT/KR2022/008566

§ 371 Date: Nov. 2, 2023

(30) Foreign Application Priority Data
Jun. 24, 2021 (KR) 10-2021-0082602

(51) Int. Cl. A24F 40/44; A24F 40/10; A24F 40/20; A24F 40/30; A24F 40/42

(52) U.S. Cl. CPC A24F 40/44; A24F 40/10; A24F 40/20; A24F 40/30; A24F 40/42

(57) ABSTRACT

A vaporizer includes a storage unit configured to store an aerosol-generating material, a wick configured to absorb the aerosol-generating material, a heating element configured to heat the aerosol-generating material absorbed in the wick, and an accommodating unit configured to accommodate the wick, the accommodating unit including at least one support groove for supporting at least a portion of the wick and at least one storage groove for temporarily storing the aerosol-generating material to deliver the aerosol-generating material to the wick, wherein a maximum width of the storage groove is greater than a maximum width of the support groove.

### TECHNICAL FIELD

Embodiments relate to a vaporizer and an aerosol-generating device including the vaporizer, and more particularly, to a vaporizer for increasing an aerosol generation amount and an aerosol-generating device including the vaporizer.

### BACKGROUND ART

Recently, the demand for alternative methods to overcome the disadvantages of traditional cigarettes has increased. For example, there is growing demand for an aerosol-generating device which generates an aerosol by heating an aerosol-generating material, rather than by combusting cigarettes. Accordingly, researches on a heating-type aerosol-generating device have been actively conducted.

A heating-type aerosol-generating device may include, for example, a vaporizer that heats an aerosol-generating material in a liquid state or a gel state. The vaporizer may store the aerosol-generating material therein, deliver the stored aerosol-generating material to a delivery element such as a wick, and heat the aerosol-generating material through a heating element positioned adjacent to the delivery element to generate an aerosol. The generated aerosol may be discharged to the outside through a passage formed in the vaporizer and/or the aerosol-generating device.

### DISCLOSURE OF INVENTION

### Technical Problem

In order to generate an aerosol abundantly and uniformly from an aerosol-generating device, an aerosol-generating material stored in a vaporizer needs to be delivered abundantly and uniformly to a delivery element such as a wick.

Otherwise, if the aerosol-generating material inside the vaporizer is not sufficiently delivered to the wick, the amount of generated aerosol may be insufficient or the aerosol may not be generated uniformly due to lack of the aerosol-generating material to be heated by a heating element.

Technical aspects, features and advantages to be achieved by the embodiments are not limited to the above-described problems, and embodiments that are not mentioned in the disclosure will be clearly understood by one of ordinary skill in the art from the present disclosure and the accompanying drawings.

### Solution to Problem

Embodiments provide a vaporizer having an improved structure so that an aerosol stored in the vaporizer may be abundantly and uniformly delivered to a wick, and an aerosol-generating device including the vaporizer.

A vaporizer according to an embodiment includes a storage unit configured to storing an aerosol-generating material, a wick configured to absorb the aerosol-generating material, a heating element configured to heat the aerosol-generating material absorbed in the wick, and an accommodating unit configured to accommodate the wick and including at least one support groove for supporting at least a portion of the wick and at least one storage groove for temporarily storing the aerosol-generating material to deliver the aerosol-generating material to the wick, wherein a maximum width of the storage groove is greater than a maximum width of the support groove.

An aerosol-generating device according to an embodiment includes the vaporizer, and a processor configured to control power supplied to the heating element in the vaporizer.

### Advantageous Effects of Invention

The vaporizer according to the embodiment described above may increase the amount of generated aerosol by increasing the amount of aerosol-generating material delivered to a wick from a storage unit.

In addition, the vaporizer according to the embodiment described above may maintain a uniform delivery amount of the aerosol-generating material due to a structure in which air bubbles interfering with the movement of the aerosol-generating material inside the vaporizer may be easily removed.

The effects according to one or embodiments are not limited to the effects described above, and unmentioned effects will be clearly understood by one of ordinary skill in the art from the present specification and the accompanying drawings.

### BRIEF DESCRIPTION OF DRAWINGS

FIG. 1 is a front view of an aerosol-generating device to which a vaporizer according to an embodiment is coupled.

FIG. 2A is an exploded perspective view of the vaporizer shown in FIG. 1;

FIG. 2B is a bottom perspective view of the vaporizer shown in FIG. 1.

FIG. 3A is a perspective view of an accommodating unit of a vaporizer according to an embodiment.

FIG. 3B is a side view of the accommodating unit shown in FIG. 3A.

FIG. 3C is a plan view of the accommodating unit shown in FIG. 3A.

FIG. 3D is a view illustrating a state in which the accommodating unit shown in FIG. 3A is in contact a sealing unit.

FIG. 4A is a perspective view of an accommodating unit of a vaporizer according to another embodiment.

FIG. 4B is a side view of the accommodating unit shown in FIG. 4A.

FIG. 4C is a plan view of the accommodating unit shown in FIG. 4A.

FIG. 5A is a perspective view of an accommodating unit of a vaporizer according to another embodiment.

FIG. 5B is a side view of the accommodating unit shown in FIG. 5A.

FIG. 5C is a plan view of the accommodating unit shown in FIG. 5A.

FIG. 6A is a perspective view of an accommodating unit of a vaporizer according to another embodiment.

FIG. 6B is a side view of the accommodating unit shown in FIG. 6A.

FIG. 6C is a plan view of the accommodating unit shown in FIG. 6A.

FIG. 7 is a diagram showing an example in which an aerosol-generating article is inserted into an aerosol-generating device according to an embodiment.

FIG. 8 is a diagram showing an example in which an aerosol-generating article is inserted into an aerosol-generating device according to another embodiment.

FIG. 9 illustrate an example of the aerosol-generating article.

### BEST MODE FOR CARRYING OUT THE INVENTION

A vaporizer according to an embodiment includes a storage unit configured to store an aerosol-generating material, a wick configured to absorb the aerosol-generating material, a heating element configured to heat the aerosol-generating material absorbed in the wick, and an accommodating unit configured to accommodate the wick, and including a support groove for supporting the wick and a storage groove for temporarily storing the aerosol-generating material to deliver the aerosol-generating material to the wick, wherein a maximum width of the storage groove is greater than a maximum width of the support groove.

The storage groove may include a first region extending in a longitudinal direction of the wick from an end portion of the wick and a second region extending in a width direction along a width axis crossing the longitudinal direction of the wick from the end portion of the wick.

The second region may extend from the end portion of the wick to both directions along the width axis.

The second region may extend from the end portion of the wick to one direction along the width axis.

The storage groove may have a width that becomes smaller toward a direction away from the storage unit.

The vaporizer may further include a sealing unit coupled to the storage unit, and having an opening through which the aerosol-generating material moves from the storage unit to the storage groove, wherein the opening may be positioned to correspond to the storage groove when the sealing unit and the accommodating unit are coupled.

The vaporizer may further include a sealing unit coupled to the storage unit, and having an opening through which the aerosol-generating material moves from the storage unit to the storage groove, wherein the maximum width of the storage groove may be equal to or greater than a maximum width of the opening.

The vaporizer may further include a sealing unit coupled to the storage unit, and having an opening through which the aerosol-generating material moves from the storage unit to the storage groove, wherein the accommodating unit and the sealing unit may form a cavity in which at least a portion of the wick is disposed.

The sealing unit may be in contact with the wick such that the sealing unit and the support groove surround at least a portion of the wick.

The sealing unit may further have an extension surface connected to the opening and inclined toward the wick.

The wick may include a first end portion, a second end portion, and a central portion between the first end portion and the second end portion, wherein the central portion of the wick and the heating element may be disposed in the cavity.

The accommodating unit may include an inlet through which outside air is introduced and an outlet through which an aerosol generated in the cavity is discharged.

The wick may be in contact with an inner surface of the storage groove.

An aerosol-generating device according to an embodiment includes the vaporizer, and a processor configured to control power supplied to the beating element of the vaporizer.

The aerosol-generating device may further include a housing including a space in which an aerosol-generating article is accommodated, and a heater configured to heat the aerosol-generating article accommodated in the housing.

### MODE FOR THE INVENTION

With respect to the terms used to describe in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c.” should be understood as including only a, only b, only c, both a and b, both a and c, both b and c, or all of a, b, and c.

Hereinafter, the present disclosure will now be described more fully with reference to the accompanying drawings, in which exemplary embodiments of the present disclosure are shown such that one of ordinary skill in the art may easily work the present disclosure. Embodiments of the present disclosure may, however, be embodied in many different forms and should not be construed as being limited to the example embodiments set forth herein.

Terms such as “first” and “second” may be used to describe various components, but the components should not be limited by the terms. The terms are only used to distinguish one component from another.

In addition, some of the components in the drawings may be illustrated with exaggerated sizes or proportions. In addition, the components shown in one figure may not be shown on another figure.

In addition, throughout the specification, the “longitudinal direction” of a component may be a direction in which the component extends along one axis of the component, and in this case, the one axis of the component may refer to a direction in which the component extends longer than the other axis transverse to the one axis.

Throughout the specification, the term “puff” refers to the user's inhalation, and the inhalation may refer to a situation in which air is drawn into the user's mouth, nasal cavity, or lungs through the user's mouth or nose.

Since various embodiments described in the specification are classified arbitrarily only for the purpose of explanation, the embodiments should not be construed to be exclusive to each other. For example, it is possible to change some features for applying or implement those features in other embodiments within scope and spirit of this disclosure.

The terms are only used to distinguish one component from another. In the present disclosure, a singular form also includes a plural form unless specifically stated in otherwise.

Hereinafter, embodiments of the present disclosure will be described more fully with reference to the accompanying drawings, in which non-limiting example embodiments of the present disclosure are shown such that one of ordinary skill in the art may easily work the present disclosure. Embodiments of the present disclosure may, however, be embodied in many different forms and should not be construed as being limited to the example embodiments set forth herein.

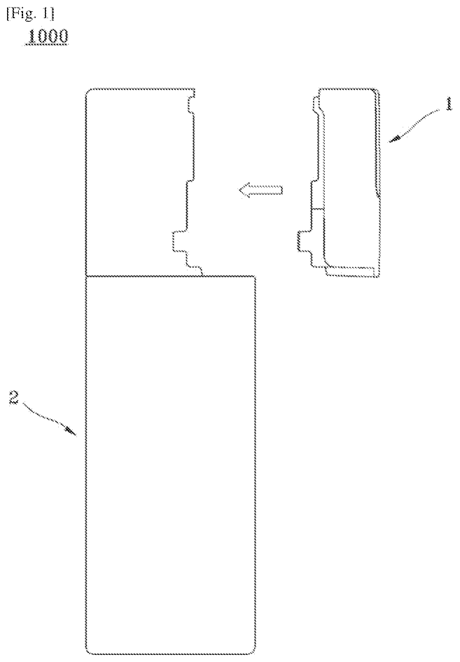

FIG. 1 is a front view of an aerosol-generating device to which a vaporizer according to an embodiment is coupled.

Referring to FIG. 1, a vaporizer 1 according to an embodiment and a body 2 may be combined with each other to operate as an aerosol-generating device 1000. For example, the vaporizer 1 may be coupled to one region of the body 2. A coupling direction of the vaporizer 1 is not limited to an example shown in FIG. 1, and the vaporizer 1 may be coupled to the body 2 in a longitudinal direction of the aerosol-generating device 1000.

In an embodiment, the aerosol-generating device 1000 may include a processor (not shown) and a battery (not shown). The battery and the processor may be electrically connected to the vaporizer 1. For example, the battery may supply power to the vaporizer 1, and the processor may control the vaporizer 1. Accordingly, the aerosol-generating device 1000 may generate an aerosol by heating a liquid or gel aerosol-generating material stored in the vaporizer 1.

In another embodiment, the aerosol-generating device 1000 may further include a housing including an accommodation space (not shown) in which an aerosol-generating article (e.g., cigarette) is inserted, and a separate heater (not shown) for heating the aerosol-generating article accommodated in the housing.

For example, the accommodation space and the heater may be in the body 2. The vaporizer 1 may be coupled to one region of the body 2, and an aerosol-generating article may be inserted in another region of the body 2.

The aerosol-generating device 1000 may not only generate an aerosol by using the vaporizer 1, but may also generate an aerosol by using an inserted aerosol-generating article. Accordingly, the aerosol-generating device 1000 may be implemented as a hybrid-type aerosol-generating device.

In another embodiment, the aerosol-generating device 1000 may further include a detachable cap (not shown) for protecting at least a portion of the body 2 and the vaporizer 1 coupled to the body 2. The detachable cap may be coupled to one end portion of the aerosol-generating device 1000 in which the vaporizer 1 and the body 2 are coupled to each other. For example, the user may separate the detachable cap separated from the body 2 to replace the vaporizer 1.

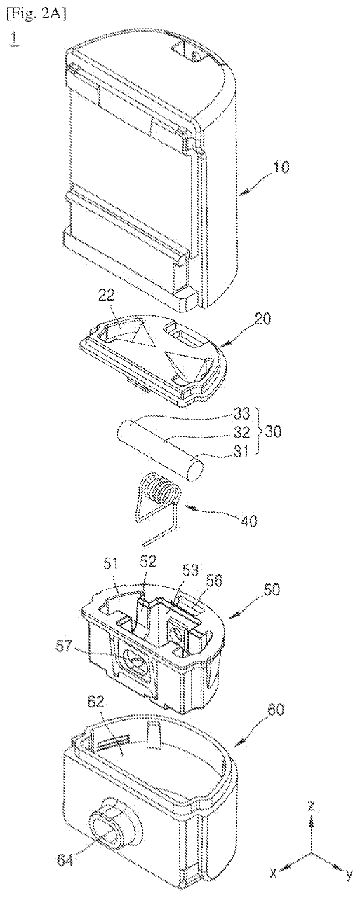

FIG. 2A is an exploded perspective view of the vaporizer 1 shown in FIG. 1, and FIG. 2B is a bottom perspective view of the vaporizer 1 shown in FIG. 1.

Referring to FIGS. 2A and 2B, the vaporizer 1 according to an embodiment may include a storage unit 10, a sealing unit 20, a wick 30, a heating element 40, an accommodating unit 50, and a cover 60. The storage unit 10, the sealing unit 20, the wick 30, the heating element 40, the accommodating unit 50, and the cover 60 may be combined in the z-axis direction shown in FIGS. 2A and 2B.

For example, after the heating element 40 and the wick 30 are accommodated in the accommodating unit 50, the accommodating unit 50 may be inserted into the cover 60, and the sealing unit 20 may be coupled to the accommodating unit 50. Accordingly, the sealing unit 20 and the accommodating unit 50 may be located inside the cover 60. Finally, the storage unit 10 and the cover 60 may be coupled to each other to assemble the vaporizer 1. However, the assembly order and coupling method of the vaporizer 1 is not limited to the aforementioned example.

The storage unit 10 may store an aerosol-generating material. The storage unit 10 may store an aerosol-generating material in a liquid state or a gel state. The aerosol-generating material stored in the storage unit 10 may be transferred to the wick 30 and absorbed by the wick 30, and the aerosol-generating material absorbed in the wick 30 may be heated by the heating element 40 to be converted into an aerosol.

At least one region of the storage unit 10 may include an opening. For example, the bottom surface of the storage unit 10 or at least a portion of the bottom surface may has an opening so that the aerosol-generating material may naturally move to the outside of the storage unit 10 by gravity.

According to an embodiment, the storage unit 10 may be coupled to the sealing unit 20 that prevents leakage of the aerosol-generating material. By the sealing unit 20 being coupled to at least one region of the storage unit 10 (e.g., an open side of the storage unit 10), the sealing unit 20 and the storage unit 10 may form a storage space 12 for accommodating the aerosol-generating material.

The sealing unit 20 may be made of a material that enables tight coupling between the sealing unit 20 and the storage unit 10. For example, the sealing unit 20 may be made of an elastic material such as rubber or silicone, but is not limited thereto.

The sealing unit 20 may be closely coupled to the storage unit 10 to prevent leakage of the aerosol-generating material. That is, the sealing unit 20 is firmly coupled to the storage unit 10 so that there is no gap between the storage unit 10 and the accommodating unit 50.

The sealing unit 20 may be manufactured to be detachable from the storage unit 10, or may be manufactured integrally with the storage unit 10.

The sealing unit 20 may have at least one opening 22 so that the aerosol-generating material stored in the storage unit 10 may move to the outside of the storage unit 10 while the storage unit 10 is coupled to the sealing unit 20.

For example, the storage unit 10 includes an open side that exposes the storage space to the outside, and the sealing unit 20 having the opening 22 may be coupled to the open side of the storage unit 10. Accordingly, the aerosol-generating material stored in the storage space 12 of the storage unit 10 may move to the outside of the storage unit 10 through the opening 22 formed in the sealing unit 20, and the aerosol-generating material stored in the storage unit 10 may be prevented from leaking to the outside of the storage unit 10 through a gap other than the opening 22.

The wick 30 may receive the aerosol-generating material from the storage unit 10 and absorb the aerosol-generating material. The wick 30 may have an elongate shape. For example, the wick 30 may have a columnar shape extending in one direction. Specifically, the wick 30 may have a polygonal columnar shape, such as a cylindrical shape, a quadrangular columnar shape, or a triangular columnar shape, but is not limited to thereto. For example, the wick 30 may have a rod shape, a needle shape, or a planar shape.

A portion of the wick 30 may absorb an aerosol-generating material supplied from the storage unit 10. For example, an aerosol-generating material absorbed into a portion of the wick 30 may move to another portion of the wick 30 according to capillary action. The wick 30 may include various types of materials. For example, the wick 30 may include at least one of cotton, ceramic, and glass fiber.

In an embodiment, the wick 30 may include a first end portion 31, a second end portion 33, and a central portion 32 between the first end portion 31 and the second end portion 33. The aerosol-generating material supplied from the storage unit 10 may be absorbed by the wick 30 through the first end portion 31 and the second end portion 33. The aerosol-generating material absorbed by the wick 30 may be moved to the central portion 32 of the wick 30.

The heating element 40 may heat the aerosol-generating material absorbed in the wick 30 and generate an aerosol. The heating element 40 may be disposed adjacent to the wick 30. The heating element 40 may generate an aerosol by heating a liquid aerosol-generating material delivered to the central portion 32 of the wick 30.

For example, the heating element 40 may be a resistive heater in the form of a coil wound around the outer circumferential surface of the central portion 32 of the wick 30. As another example, the heating element 40 may be a resistive heater printed on the central portion 32 of the wick 30. The heating element 40 is not limited to the aforementioned examples, and may be a porous element formed integrally with the wick 30.

The accommodating unit 50 may include accommodating spaces 51, 52, and 53 for accommodating the wick 30 and heating element 40. For example, the accommodating unit 50 may include at least one support groove 52 for supporting at least a portion of the wick 30, at least one storage groove 51 for temporarily storing the aerosol-generating material to deliver the aerosol-generating material to the wick 30, and a central space 53 for accommodating the central portion 32 of the wick 30.

At least a portion of the wick 30 may be in the cavity surrounded by the accommodating unit 50 and the sealing unit 20. For example, the central portion 32 of the wick 30 around which the heating element 40 is wound may be place in the cavity, and thus an aerosol may be generated in the cavity.

Outside air may be introduced into the inside of the accommodating unit 50 through an inlet 56 of the accommodating unit 50, and the aerosol generated in the cavity may be discharged to the outside of the accommodating unit 50 through an outlet 57 of the accommodating unit 50.

More detailed descriptions of the accommodating unit 50 and the support groove 52 and the storage groove 51 in the accommodating unit 50 will be given in detail with reference to other drawings.

The cover 60 may be coupled to the accommodating unit 50 and the sealing unit 20. The cover 60 may include an inner space 62 in which the accommodating unit 50 and the sealing unit 20 may be disposed. For example, the cover 60 may include an inner space 62 having a shape corresponding to the outer shapes of the accommodating unit 50 and the sealing unit 20. The accommodating unit 50 and the sealing unit 20 may be properly aligned with each other and disposed in the inner space 62 of the cover 60, and thus accommodating unit 50 and the sealing unit 20 are protected from external impact.

The cover 60 may include a connection passage 64 for guiding, to the outside of the vaporizer 1, an aerosol discharged from the outlet 57 of the accommodating unit 50. For example, in a state in which the accommodating unit 50 is disposed in the inner space 62 of the cover 60, the connection passage 64 may be located at a position corresponding to the outlet 57 such that the outlet 57 communicates with the connection passage 64. The aerosol discharged to the outside of the accommodating unit 50 through the outlet 57 may move to the outside of the vaporizer 1 along the connection passage 64.

For example, the connection passage 64 may be connected to the body 2 of the aerosol-generating device 1000. The aerosol discharged to the outside of the accommodating unit 50 through the outlet 57 may move to the body 2 of the aerosol-generating device 1000 through the connection passage 64 and be discharged to the outside of the aerosol-generating device 1000 along an airflow passage formed in the body 2.

The cover 60 may include a connection terminal 66 for electrically connecting the vaporizer 1 to the body 2. For example, the connection terminal 66 may be connected to the heating element 40 to mediate the connection of the heating element 40 with the battery and processor in the body 2. Accordingly, the heating element 40 may be powered by the battery and controlled by the processor.

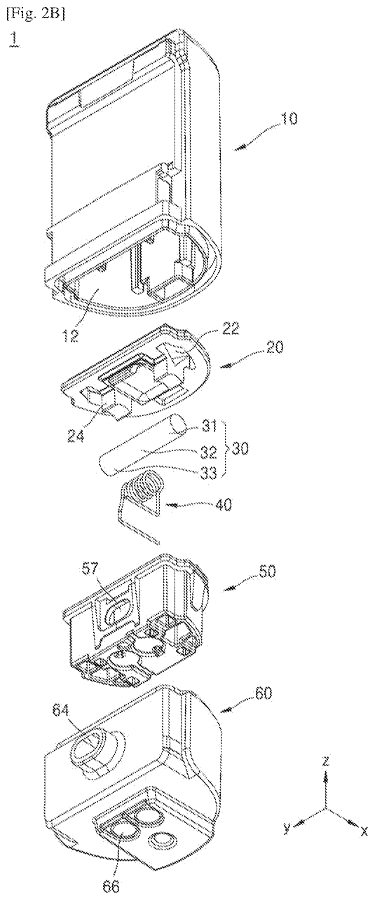

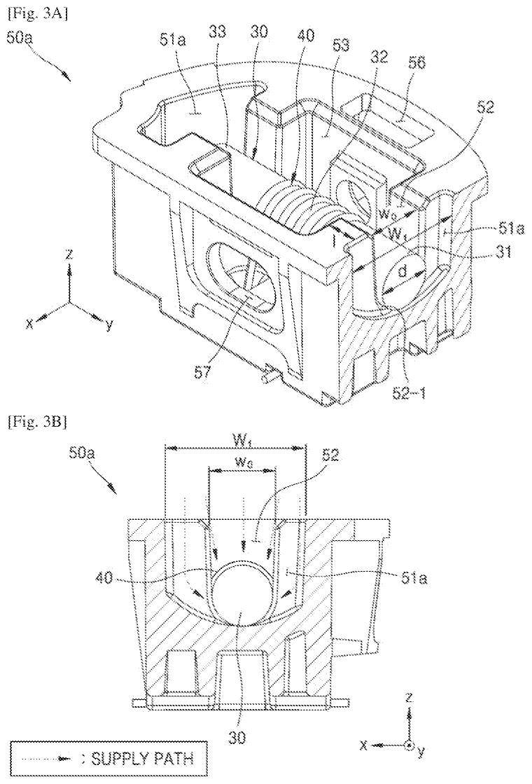

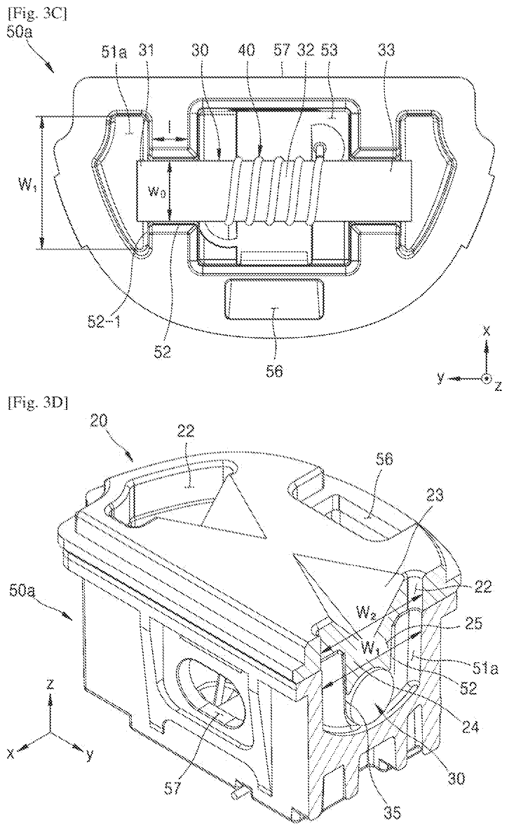

FIG. 3A is a perspective view of an accommodating unit of a vaporizer according to an embodiment, FIG. 3B is a side view of the accommodating unit shown in FIG. 3A, and FIG. 3C is a plan view of the accommodating unit shown in FIG. 3A.

Referring to FIGS. 3A to 3C, an accommodating unit 50a of the vaporizer according to an embodiment may include a storage groove 51a, a support groove 52, a central space 53, an inlet 56, and an outlet 57. In this case, a wick 30 and a heating element 40 may be located in accommodating spaces (i.e., the storage groove 51a, the support groove 52, and the central space 53) of the accommodating unit 50a.

As shown in FIGS. 3A to 3C, the heating element 40 may be disposed to surround the outer circumferential surface of the wick 30 accommodated in the accommodating unit 50a, but the arrangement structure of the heating element 40 is not limited thereto.

For example, the heating element 40 may have a plate shape and be disposed adjacent to at least a portion of the wick 30 accommodated in the accommodating unit 50a to heat the wick 30. As another example, the heating element 40 may be a porous heater (e.g., a ceramic heater) formed integrally with the wick 30.

The support groove 52 may have a specified length 1 in a longitudinal direction (e.g., y-axis direction) of the wick 30 to support at least a portion of the wick 30, and may have a width w, corresponding to the size (e.g., a diameter d) of the wick 30 in a direction (e.g., x-axis direction) crossing the longitudinal direction of the wick 30. Accordingly, the inner surface of the support groove 52 may be in contact with at least a portion of the outer circumferential surface of the wick 30, thereby supporting the wick 30.

The storage groove 51a may be a space in which an aerosol-generating material supplied from a storage unit is temporarily stored or retained. The aerosol-generating material that has moved out of the storage unit through an opening (e.g., the opening 22 of FIG. 2A) formed in a sealing unit (e.g., the sealing unit 20 of FIG. 2A) may first be delivered to the storage groove 51a. The aerosol-generating material temporarily stored or retained in the storage groove 51a may permeate into a central portion 32 of the wick 30 from first and second end portions 31 and 33 of the wick 30 located in the storage groove 51a.

In an embodiment, the accommodating unit 50a may include a plurality of support grooves 52 formed to support the first end portion 31 and the second end portion 33 of the wick 30 accommodated in the accommodating unit 50a. In addition, the accommodating unit 50a may include a storage groove 51a that temporarily stores an aerosol-generating material supplied from the storage unit and delivers the aerosol-generating material toward the first end portion 31 and the second end portion 33 of the wick 30 accommodated in the accommodating unit 50a.

For example, the support groove 52 may be located at a position apart from the central space 53 forming a portion of the cavity of the accommodating unit 50a by a predetermined distance in the longitudinal direction of the wick 30. That is, the storage groove 51a may be located at a position farther than the support groove 52 from the central space 53 or the cavity.

The wick 30 may contact the inner surface of the support groove 52. For example, the size d of the wick 30 and the width w, of the support groove 52 may be within a fitting tolerance range so that the wick 30 may be fitted into the support groove 52.

The wick 30 accommodated in the accommodating unit 50a may extend from the central space 53 of the accommodating unit 50a to an end 52-1 of the support groove 52. The wick 30 accommodated in the accommodating unit 50a may extend beyond the end 52-1 of the support groove 52 to the inside of the storage groove 51a. At least a portion of the wick 30 accommodated in the accommodating unit 50a may contact at least a portion of the inner surface of the storage groove 51a. Accordingly, the wick 30 accommodated in the accommodating unit 50a may have an increased contact area with the aerosol-generating material retained in the storage groove 51a, and thus a larger amount of the aerosol-generating material may be absorbed.

When the heating element 40 is located at the central portion 32 of the wick 30, an aerosol-generating material supplied to the wick 30 through both end portions of the wick 30 has to be delivered to the central portion 32 of the wick 30 so that an aerosol may be generated by the heating element 40. That is, in order to smoothly generate an aerosol in the central portion 32 of the wick 30, it is important that the aerosol-generating material be smoothly supplied to the wick 30 through both end portions of the wick 30.

According to an embodiment, a maximum width W₁ of the storage groove 51a may be greater than a maximum width w, of the support groove 52. In this case, the maximum width W₁ may refer to the longest width of the storage groove 51a among distances measured in the direction (e.g., the x-axis direction) crossing the longitudinal direction of the wick 30.

For example, the storage groove 51a may include a region extending in the longitudinal direction of the wick 30 from the first and second end portions 31 and 33 of the wick 30, and a region extending in a width direction of the wick 30 (i.e., a direction crossing the longitudinal direction of the wick 30) from the first and second end portions 31 and 33 of the wick 30. In this case, the region extending in the width direction may extend from the first and second end portions 31 and 33 of the wick 30 to one or both directions along the width axis (i.e., x-axis) of the wick 30.

As the storage groove 51a has a wider maximum width than the support groove 52, the storage groove 51a may retain more aerosol-generating material supplied from the storage unit, and the surface area of the wick 30 in contact with the aerosol-generating material retained in the storage groove 51a may increase.

Accordingly, a supply route of the aerosol-generating material may be expanded. The wick 30 may absorb the aerosol-generating material through the circumferential surfaces of the first and second end portions 31 and 33, as well as through the side surfaces of the first and second end portions 31 and 33. As a result, the amount of aerosol-generating material absorbed by the wick 30 may increase, thereby increasing the amount of aerosol generated by the vaporizer.

FIG. 3D is a view illustrating a state in which the accommodating unit 50a shown in FIG. 3A is in contact a sealing unit.

Referring to FIG. 3D, a sealing unit 20 having an opening 22 through which an aerosol-generating material moves may contact or be coupled to the accommodating unit 50a. In this case, the sealing unit 20 may be in contact with the accommodating unit 50a in a state in which the sealing unit 20 is coupled to a storage unit 10. However, the storage unit 10 is omitted for better understanding.

In an embodiment, in order for the aerosol-generating material stored in the storage unit to move to the storage groove 51a, the opening 22 may be located in a position corresponding to a storage groove 51a when the storage unit and the accommodating unit 50a are coupled to each other.

For example, the opening 22 may be located to form a movement passage 25 connected to the storage groove 51a when the sealing unit 20 comes into contact with the accommodating unit 50a. Accordingly, the amount of the aerosol-generating material leaking between the accommodating unit 50a and the storage unit 10 and/or the sealing unit 20 may be reduced, and the aerosol-generating material may be efficiently supplied to the storage groove 51a.

As described above, the accommodating unit 50a may include an inlet 56 through which outside air is introduced into the vaporizer. The outside air introduced into the inside of the vaporizer may pass through a cavity (not shown) where an aerosol is generated and may be discharged to the outside of the vaporizer through the outlet 57. In this way, the circulation of airflow may be made in the inside of the vaporizer.

When the aerosol-generating material stored in the storage unit 10 and/or the storage groove 51a moves to the central space 53 through the wick 30, a pressure difference may occur between the central space 53 and the storage unit 10 and/or the storage groove 51a.

A portion of the outside air introduced into the cavity may flow backward in a direction (e.g., +y direction or −y direction) counter to a movement direction (e.g., the y direction or +y direction) of the aerosol-generating material that moves from one end portion of the wick 30 to the central portion of the wick 30, to compensate for the pressure difference. As a result, a portion of the outside air may move to the storage groove 51a and/or the opening 22, and bubbles may be formed in the storage groove 51a and/or the opening 22.

The bubbles formed in the opening 22 and/or the storage groove 51a may narrow or close the movement passage 25 of the aerosol-generating material supplied from the storage unit to the storage groove 51a, and thus uniform supply of the aerosol-generating material from the storage unit to the storage groove 51a may be inhibited. Accordingly, an internal structure of the vaporizer may be configured to prevent the movement passage 25 of the aerosol-generating material from being blocked by air bubbles.

According to the embodiment according to FIG. 3D, the size of the opening 22 may correspond to the size of the inlet side of the storage groove 51a from which the aerosol-generating material is supplied. For example, the maximum width W₁ of the storage groove 51a may be equal to or greater than a maximum width W₂ of the opening 22. As another example, the ratio of the maximum width W₁ of the storage groove 51a to the maximum width W₂ of the opening 22 may correspond to approximately 1:0.8 to 1:1.2.

In this way, as the size of the opening 22 and the size of the inlet side of the storage groove 51a correspond to each other, the movement passage 25 through which the aerosol-generating material moves may be maximized, and thus a bottleneck effect caused by a size difference between the opening 22 and the storage groove 51a may be prevented. In addition, even if bubbles are generated in the storage groove 51a and/or the opening 22, the bubbles may be easily removed, and thus the clogging of the movement passage 25 through which the aerosol-generating material moves may be prevented.

In an embodiment, the sealing unit 20 may further have an extension surface 23 connected to the opening 22 and inclined toward the wick 30. The aerosol-generating material may be in a liquid or gel state having high viscosity, and thus there is a risk that the speed of the aerosol-generating material passing through a narrow passage may be slowed or the narrow passage may be blocked by a film formed in the narrow passage. According to an embodiment, an aerosol-generating material stored in the storage unit 10 may enter the opening 22 along the extension surface 23 formed at a position adjacent to the storage groove 51a and thus easily move to the outside of the storage unit 10 (e.g., to the storage groove 51a).

Referring to FIG. 3D, the sealing unit 20 may be in contact with the sealing unit 20 and the wick 30 accommodated in the accommodating unit 50a. As a result, at least a portion of the wick 30 may be surrounded by the sealing unit 20 and the accommodating unit 50a. For example, the peripheries of both end portions of the wick 30 may be in contact with portions of the support groove 52 and the sealing unit 20, and thus, both end portions of the wick 30 may be surrounded by the support groove 52 and the sealing unit 20.

In an embodiment, the sealing unit 20 may include a support portion 24 protruding in a direction (e.g., −z direction) away from the storage unit (e.g., the storage unit 10 of FIG. 2A). The support portion 24 may be formed at a position facing the support groove 52 when the sealing unit 20 is in contact with the accommodating unit 50a, and the support portion 24 may be inserted into the support groove 52.

Both end portions of the wick 30 located between the accommodating unit 50a and the sealing unit 20 may be in contact with the support groove 52 and the support portion 24. That is, lower portions of the end portions of the wick 30 may be surrounded by the support groove 52 and the upper portions of the end portions of the wick 30 may be surrounded by the support portion 24 inserted into the support groove 52.

Accordingly, a gap 35 between the outer circumferential surface of the wick 30 and the support groove 52 and/or the support portion 24 may be reduced, and thus the leakage from the storage groove 51a toward the central space 53 may be reduced.

As a result, most of the aerosol-generating material retained in the storage groove 51a may move to the central portion of the wick 30 through the end portions of the wick 30, and the amount of aerosol-generating material leaking out of the vaporizer may be reduced.

The position of the wick 30 may be fixed by the sealing unit 20 and the accommodating unit 50a. For example, the end portions of the wick 30 located in the support groove 52 may be pressed by the support portion 24 and/or the support groove 52, and thus the position of the wick 30 may be maintained.

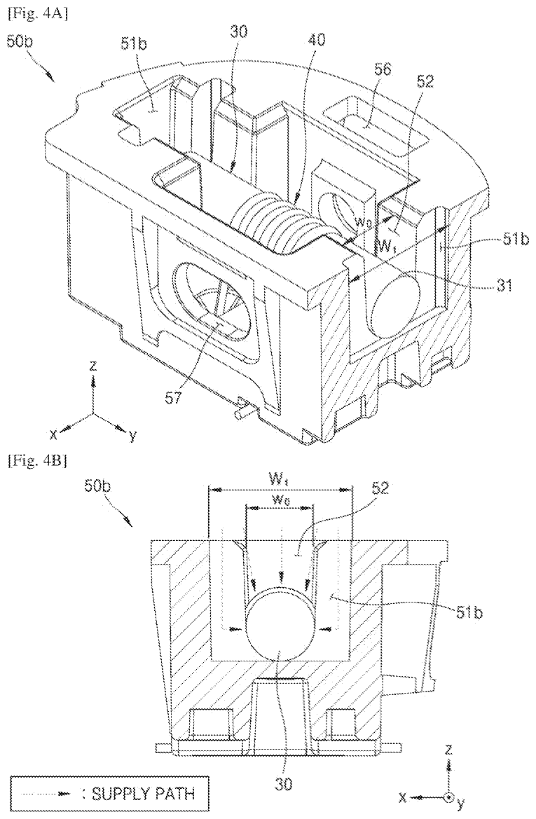

FIG. 4A is a perspective view of an accommodating unit in a vaporizer according to another embodiment, FIG. 4B is a side view of the accommodating unit shown in FIG. 4A, and FIG. 4C is a plan view of the accommodating unit shown in FIG. 4A.

Referring to FIGS. 4A to 4C, an accommodating unit 50b in the vaporizer according to another embodiment may include a storage groove 51b having a different structure from the storage groove 51a of the accommodating unit 50a in the vaporizer shown in FIGS. 3A to 3C.

Referring to FIG. 4C, the storage groove 51b may include a first region 51b-1 and a second region 51b-2. The first region 51b-1 may be a region extending from the end portion 31 of a wick 30, which is accommodated in the accommodating unit 50b, in a longitudinal direction (e.g., y-axis direction) of the wick 30. The second region 51b-2 may be a region extending from the end portion 31 of the wick 30 in a width direction (e.g., x-axis direction) of the wick 30. The second region 51b-2 extending in a width direction of the wick 30 may extend from the end 31 of the wick 30 in both directions (e.g., +x and −x directions) crossing the longitudinal direction of the wick 30.

For example, a cross-section of the storage groove 51b formed by the intersection of the x-z plane (i.e., a cross-section taken along a width direction of the wick 30 crossing the longitudinal direction of the wick 30) may be approximately rectangular or trapezoidal. In this cross section, a width W; of the second region 51b-2 of the storage groove 51b may be greater than a width Wj′ of the first region 51b-1 of the storage groove 51b.

The width W₁′ of the first region 51b-1 of the storage groove 51b may have no relationship with the width w₀ of the support groove 52.

An aerosol-generating material retained in the first region 51b-1 of the storage groove 51b may be efficiently absorbed into the wick 30 through the side surface of the end portion 31 of the wick 30. An aerosol-generating material retained in the second region 51b-2 of the storage groove 51b may be efficiently absorbed into the wick 30 through the outer circumferential surface of the end portion 31 of the wick 30.

As such, since the space of the storage groove 51b includes a region extending in the longitudinal and width directions of the wick 30, the amount of aerosol-generating material that may be retained by the storage groove 51b may increase. Also, a supply path through which the aerosol-generating material is absorbed into the wick 30 may be expanded.

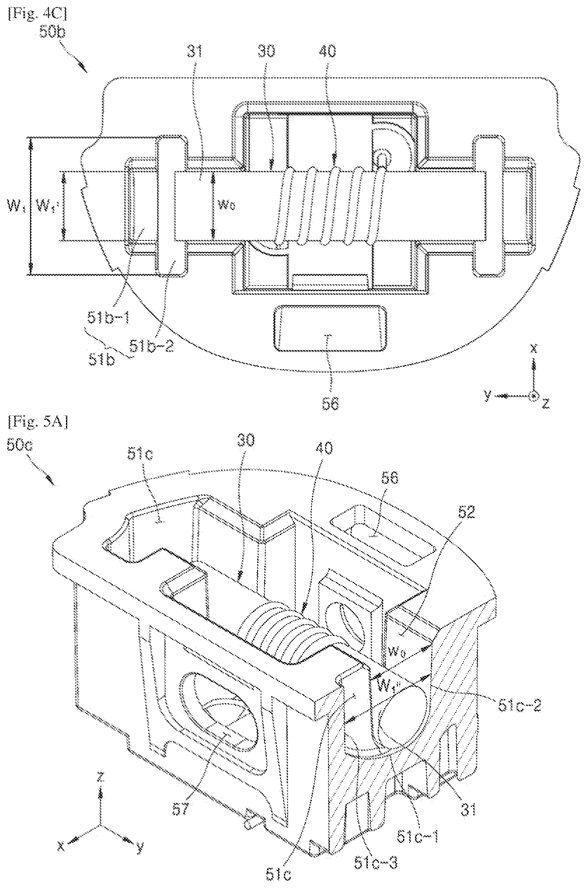

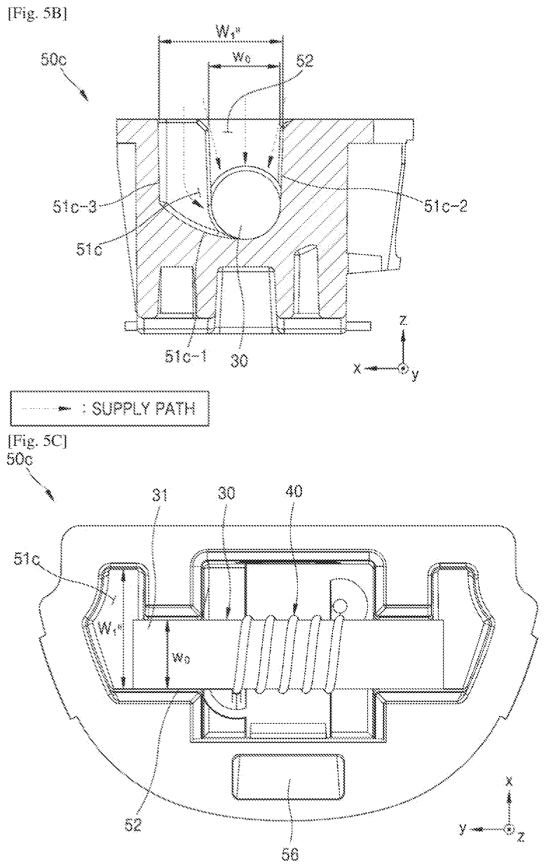

FIG. 5A is a perspective view of an accommodating unit of a vaporizer according to another embodiment, FIG. 5B is a side view of the accommodating unit shown in FIG. 5A, and FIG. 5C is a plan view of the accommodating unit shown in FIG. 5A.

Referring to FIGS. 5A to 5C, an accommodating unit 50c of the vaporizer according to another embodiment may include a storage groove 51c having a different structure from the storage grooves 51a and 51b of the accommodating units 50a and 50b in the vaporizers shown in FIGS. 3A to 4C.

According to the embodiment shown in FIGS. 5A to 5C, the storage groove 51e may include a first region extending from the end portion 31 of a wick 30 in a longitudinal direction (e.g., y-axis direction) of the wick 30, and a second region extending from the end portion 31 of the wick 30 in a width direction (e.g., x-axis direction) of the wick 30. The second region extending in a width direction of the wick 30 may extend from one end 31 of the wick 30 in one direction (e.g., +x direction).

For example, referring to FIG. 5B, when viewed from a cross-section of the storage groove 51c formed by the intersection of the x-z plane, the storage groove 51c may include a bottom surface 51c-1, a first sidewall surface 51c-2, and a second sidewall surface 51c-3.

The bottom surface 51c-1 and the first sidewall surface 51c -2 may be in contact with at least a portion of the wick 30. The second sidewall surface 51c-3 may be apart from the wick 30 and the first sidewall surface 51c-2 in a width direction (i.e., x axis direction) of the wick 30. In this case, a maximum width W₁″ of the storage groove 51c, which is the longest distance between the first sidewall surface 51c-2 and the second sidewall surface 51c-3, may be greater than a maximum width w, of a support groove 52.

The structure of the storage groove 51c may be designed in consideration of a tradeoff between the amount of storage or retention of an aerosol-generating material and the leakage of an aerosol-generating material in the vaporizer.

According to the embodiment shown in FIGS. 5A-5C, a space inside the storage groove 51c is expanded to the extent that a sufficient amount of aerosol-generating material can be supplied to the wick 30. That is, the storage groove 51c only expands in one width direction (e.g., +x direction), the leakage of the aerosol-generating material may be reduced while a supply path of the aerosol generating material is expanded to a certain extent.

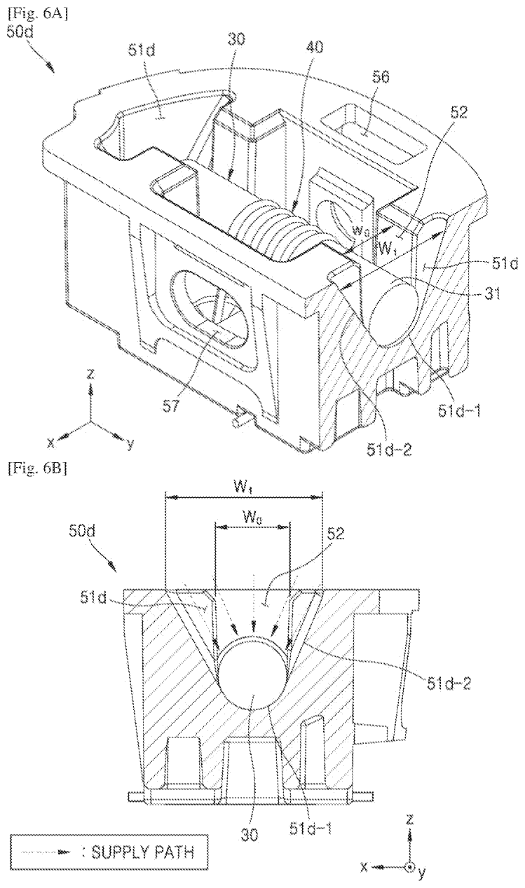

FIG. 6A is a perspective view of an accommodating unit in a vaporizer according to another embodiment, FIG. 6B is a side view of the accommodating unit shown in FIG. 6A, and FIG. 6C is a plan view of the accommodating unit shown in FIG. 6A.

Referring to FIGS. 6A to 6C, an accommodating unit 50d in the vaporizer according to another embodiment may include a storage groove 51d having a different structure from the storage grooves 51a, 51b, and 51c of the accommodating units 50a, 50b, and 50c in the vaporizers shown in FIGS. 3A to 5C.

According to another embodiment, the width of the storage groove 51d may decrease towards a direction (e.g., −z direction) away from a storage unit. That is, the storage groove 51d may have a tapered shape that has a wide inlet through which an aerosol-generating material is supplied and becomes narrower toward the depth direction (e.g., −z direction) of the storage groove 51d.

For example, referring to FIG. 6B, when viewed from a cross-section of the storage groove 51d formed by the intersection of the x-z plane, the storage groove 51d may include a curved surface 51d -1 and an inclined surface 51d-2.

The curved surface 51d-1 may be a surface formed to contact the wick 30 along a circumferential direction of the wick 30. The inclined surface 51d-2 may be a surface formed so that the storage groove 51d becomes narrower toward the depth direction of the storage groove 51d. In this case, the angle of the inclined surface 51d-2 may be designed differently according to embodiments, and the volume of a space inside the storage groove 51d may change according to the angle of the inclined surface 51d-2.

As the storage groove 51d has a width that becomes narrower toward the direction away from the storage unit, the possibility of leakage of the aerosol-generating material may be reduced.

In addition, the curved surface 51d-1 and/or the inclined surface 51d-2 of the storage groove 51d may surround at least a portion of the wick 30, and thus an aerosol-generating material supplied from the storage unit may be guided to the wick 30 along a supply path formed by the inclined surface 51d-2. According to the above-described embodiment, the formation of a dead space in which the aerosol-generating material accumulates may be minimized in the storage groove 51d.

The structures of the wick 30, the heating element 40, and the accommodating units 50a, 50b, 50c, and 50d in which the support groove 52 and the storage grooves 51a, 51b, 51c, and 51d, shown in FIGS. 3a to 6c, are merely examples and may be modified into various forms.

For example, the heating element 40 may be disposed adjacent to the wick 30 without being wound around the wick 30. The wick 30 may have a mesh shape or a plate shape rather than an elongate shape. In addition, the position and number of the storage grooves 51a, 52b, 52c, and 52d, the support groove 52, the inlet 56, and the outlet 57 in the accommodating units 50a, 50b, 50c, and 50d may be changed.

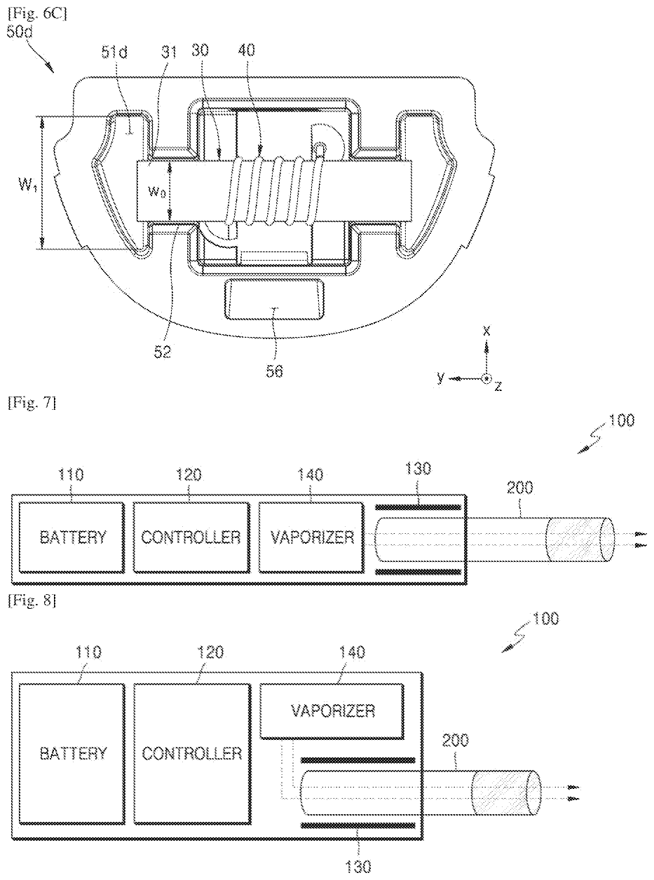

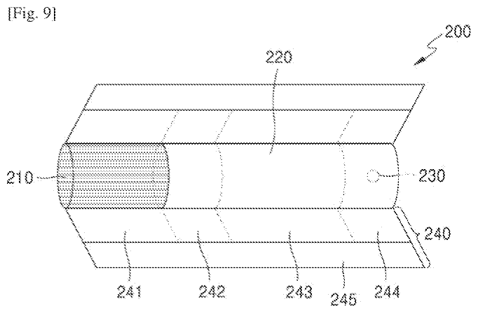

FIG. 7 is a view illustrating an example in which an aerosol-generating article is inserted into an aerosol-generating device according to an embodiment, and FIG. 8 is a view illustrating an example in which an aerosol-generating article is inserted into an aerosol-generating device according to another embodiment.

Referring to FIGS. 7 and 8, the aerosol-generating device 100 may include a battery 110, a controller 120, a heater 130, and a vaporizer 140. Also, the aerosol-generating article 200 may be inserted into an inner space of the aerosol-generating device 100. For example, an aerosol-generating device 100 of FIG. 8 may be the same as the aerosol-generating device 1000 of FIG. 1, and a vaporizer 140 applied to the aerosol-generating device 100 of FIGS. 7 and 8 may be the same as the vaporizer 1 of FIG. 2A.

The aerosol-generating device 100 illustrated in FIGS. 7 and 8 includes the vaporizer. However, the embodiments are not limited to the implementation method thereof, and the vaporizer may be omitted. In case the vaporizer is omitted from the aerosol-generating device 100, the aerosol-generating article 200 contains an aerosol-generating material, so that the aerosol-generating article 200 generates aerosol when the aerosol-generating article 200 is heated by the heater 130.

FIGS. 7 and 8 illustrate components of the aerosol-generating device 100, which are related to the present embodiment. Therefore, it will be understood by one of ordinary skill in the art related to the present embodiment that other general-purpose components may be further included in the aerosol-generating device 100, in addition to the components illustrated in FIGS. 7 and 8.

Also, FIGS. 7 and 8 illustrate that the aerosol-generating device 100 includes the heater 130. However, as necessary, the heater 130 may be omitted.

FIG. 7 illustrates that the battery 110, the controller 120, the vaporizer 140, and the heater 130 are arranged in series. Also, FIG. 8 illustrates that the vaporizer 140 and the heater 130 are arranged in parallel. However, the internal structure of the aerosol-generating device 100 is not limited to the structures illustrated in FIG. 7 or 8. In other words, according to the design of the aerosol-generating device 100, the battery 110, the controller 120, the vaporizer 140, and the heater 130 may be differently arranged.

When the aerosol-generating article 200 is inserted into the aerosol-generating device 100, the aerosol-generating device 100 may operate the vaporizer 140 to generate aerosol from the vaporizer 140. The aerosol generated by the vaporizer 140 is delivered to a user by passing through the aerosol-generating article 200. The vaporizer 140 will be described in more detail later.

The battery 110 may supply power to be used for the aerosol-generating device 100 to operate. For example, the battery 110 may supply power to heat the heater 130 or the vaporizer 140, and may supply power for operating the controller 120. Also, the battery 110 may supply power for operations of a display, a sensor, a motor, etc. mounted in the aerosol-generating device 100.

The controller 120 may generally control operations of the aerosol-generating device 100. In detail, the controller 120 may control not only operations of the battery 110, the heater 130, and the vaporizer 140, but also operations of other components included in the aerosol-generating device 100. Also, the controller 120 may check a state of each of the components of the aerosol-generating device 100 to determine whether or not the aerosol-generating device 100 is able to operate.

The controller 120 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The heater 130 may be heated by the power supplied from the battery 110. For example, when the aerosol-generating article 200 is inserted into the aerosol-generating device 100, the heater 130 may be located outside the aerosol-generating article 200. Thus, the heated heater 130 may increase a temperature of an aerosol-generating material in the aerosol-generating article 200.

The heater 130 may include an electro-resistive beater. For example, the heater 130 may include an electrically conductive track, and the heater 130 may be heated when currents flow through the electrically conductive track. However, the heater 130 is not limited to the example described above and may include any other heaters which may be heated to a desired temperature. Here, the desired temperature may be pre-set in the aerosol-generating device 100 or may be set by a user.

As another example, the heater 130 may include an induction heater. In detail, the heater 130 may include an electrically conductive coil for heating an aerosol-generating article in an induction heating method, and the aerosol-generating article may include a susceptor which may be heated by the induction heater.

FIGS. 7 and 8 illustrate that the heater 130 is positioned outside the aerosol-generating article 200, but the position of the heater 130 is not limited thereto. For example, the heater 130 may include a tube-type heating element, a plate-type heating element, a needle-type heating element, or a rod-type heating element, and may heat the inside of the outside of the aerosol-generating article 200, according to the shape of the heating element.

Also, the aerosol-generating device 100 may include a plurality of heaters 130. Here, the plurality of heaters 130 may be inserted into the aerosol-generating article 200 or may be arranged outside the aerosol-generating article 200. Also, some of the plurality of heaters 130 may be inserted into the aerosol-generating article 200 and the others may be arranged outside the aerosol-generating article 200. In addition, the shape of the heater 130 is not limited to the shapes illustrated in FIGS. 7 and 8 and may include various shapes.

The vaporizer 140 may generate aerosol by heating a liquid composition and the generated aerosol may pass through the aerosol-generating article 200 to be delivered to a user. In other words, the aerosol generated via the vaporizer 140 may move along an air flow passage of the aerosol-generating device 100 and the air flow passage may be configured such that the aerosol generated via the vaporizer 140 passes through the aerosol-generating article 200 to be delivered to the user.

For example, the vaporizer 140 may include a liquid storage, a liquid delivery element, and a heating element, but it is not limited thereto. For example, the liquid storage, the liquid delivery element, and the heating element may be included in the aerosol-generating device 100 as independent modules. The liquid storage, a liquid delivery element, and a heating element may be identical with the storage unit 10 the wick 30, and heating element 40 Included in the vaporizer 1 shown in FIG. 2A.

The liquid storage may store a liquid composition. For example, the liquid composition may be a liquid including a tobacco-containing material having a volatile tobacco flavor component, or a liquid including a non-tobacco material. The liquid storage may be formed to be detachable from the vaporizer 140 or may be formed integrally with the vaporizer 140.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors of tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 140 may be referred to as a cartomizer or an atomizer, but it is not limited thereto.

The aerosol-generating device 100 may further include general-purpose components in addition to the battery 110, the controller 120, the heater 130, and the vaporizer 140. For example, the aerosol-generating device 100 may include a display capable of outputting visual information and/or a motor for outputting haptic information. Also, the aerosol-generating device 100 may include at least one sensor (a puff sensor, a temperature sensor, an aerosol-generating article insertion detecting sensor, etc.). Also, the aerosol-generating device 100 may be formed as a structure that, even when the aerosol-generating article 200 is inserted into the aerosol-generating device 100, may introduce external air or discharge internal air.

Although not illustrated in FIGS. 7 and 8, the aerosol-generating device 100 and an additional cradle may form together a system. For example, the cradle may be used to charge the battery 110 of the aerosol-generating device 100. Alternatively, the heater 130 may be heated when the cradle and the aerosol-generating device 100 are coupled to each other.

The aerosol-generating article 200 may be similar to a general combustive cigarette. For example, the aerosol-generating article 200 may be divided into a first portion including an aerosol-generating material and a second portion including a filter, etc. Alternatively, the second portion of the aerosol-generating article 200 may also include an aerosol-generating material. For example, an aerosol-generating material made in the form of granules or capsules may be inserted into the second portion.

The first portion may be completely inserted into the aerosol-generating device 100, and the second portion may be exposed to the outside. Alternatively, only a portion of the first portion may be inserted into the aerosol-generating device 100, or a portion of the first portion and a portion of the second portion may be inserted thereinto. The user may puff aerosol while holding the second portion by the mouth of the user. In this case, the aerosol is generated by the external air passing through the first portion, and the generated aerosol passes through the second portion and is delivered to the user's mouth.

For example, the external air may flow into at least one air passage formed in the aerosol-generating device 100. For example, opening and closing of the air passage and/or a size of the air passage formed in the aerosol-generating device 100 may be adjusted by the user. Accordingly, the amount and the quality of smoking may be adjusted by the user. As another example, the external air may flow into the aerosol-generating article 200 through at least one hole formed in a surface of the aerosol-generating article 200.

FIG. 9 illustrates am example of the aerosol-generating article.

FIG. 9 is a diagram illustrating an example of the aerosol-generating article.

Referring to FIG. 9, the aerosol-generating article 200 includes a tobacco rod 210 and a filter rod 220. The first portion described above with reference to FIGS. 7 and 8 may include the tobacco rod 210, and the second portion may include the filter rod 220.

FIG. 9 illustrates that the filter rod 220 includes a single segment, but is limited thereto. In other words, the filter rod 220 may include a plurality of segments. For example, the filter rod 220 may include a first segment configured to cool an aerosol and a second segment configured to filter a certain component included in the aerosol. Also, as necessary, the filter rod 220 may further include at least one segment configured to perform other functions.

The aerosol-generating article 200 may be packaged by at least one wrapper 240. The wrapper 240 may have at least one hole through which external air may be introduced or internal air may be discharged. For example, the aerosol-generating article 200 may be packaged by one wrapper 240. As another example, the aerosol-generating article 200 may be doubly packaged by two or more wrappers 240. For example, the tobacco rod 210 may be packaged by a first wrapper 241, and the filter rod 220 may be packaged by wrappers 242, 243, 244. Also, the entire aerosol-generating article 200 may be re-packaged by another single wrapper 245. When the filter rod 220 includes a plurality of segments, each segment may be packaged by wrappers 242, 243, 244.

The tobacco rod 210 may include an aerosol-generating material. For example, the aerosol-generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 210 may include other additives, such as flavors, a wetting agent, and/or organic acid. Also, the tobacco rod 210 may include a flavored liquid, such as menthol or a moisturizer, which is injected to the tobacco rod 210.

The tobacco rod 210 may be manufactured in various forms. For example, the tobacco rod 210 may be formed as a sheet or a strand. Also, the tobacco rod 210 may be formed as a pipe tobacco, which is formed of tiny bits cut from a tobacco sheet. Also, the tobacco rod 210 may be surrounded by a heat conductive material. For example, the heat conductive material may be, but is not limited to, a metal foil such as aluminum foil. For example, the heat conductive material surrounding the tobacco rod 210 may uniformly distribute heat transmitted to the tobacco rod 210, and thus, the heat conductivity applied to the tobacco rod may be increased and taste of the tobacco may be improved. Also, the heat conductive material surrounding the tobacco rod 210 may function as a susceptor heated by the induction heater. Here, although not illustrated in the drawings, the tobacco rod 210 may further include an additional susceptor, in addition to the heat conductive material surrounding the tobacco rod 210.

The filter rod 220 may include a cellulose acetate filter. Shapes of the filter rod 220 are not limited. For example, the filter rod 220 may include a cylinder-type rod or a tube-type rod having a hollow inside. Also, the filter rod 220 may include a recess-type rod. When the filter rod 220 includes a plurality of segments, at least one of the plurality of segments may have a different shape.

The filter rod 220 may be formed to generate flavors. For example, a flavoring liquid may be injected onto the filter rod 220, or an additional fiber coated with a flavoring liquid may be inserted into the filter rod 220.

Also, the filter rod 220 may include at least one capsule 230. Here, the capsule 230 may generate a flavor or an aerosol. For example, the capsule 230 may have a configuration in which a liquid containing a flavoring material is wrapped with a film. For example, the capsule 230 may have a spherical or cylindrical shape, but is not limited thereto.

When the filter rod 220 includes a segment configured to cool the aerosol, the cooling segment may include a polymer material or a biodegradable polymer material. For example, the cooling segment may include pure polylactic acid alone, but the material for forming the cooling segment is not limited thereto. In some embodiments, the cooling segment may include a cellulose acetate filter having a plurality of holes. However, the cooling segment is not limited to the above-described example and is not limited as long as the cooling segment cools the aerosol.

The one or more embodiments may also be implemented in the form of a recording medium including instructions executable by a computer, such as a program module executable by a computer. A computer-readable medium may be any available media that may be accessed by a computer and includes both volatile and nonvolatile media, and removable and non-removable media. In addition, the computer-readable medium may include a computer storage medium and a communication medium. The computer storage includes both volatile and nonvolatile, and removable and non-removable media implemented in any method or technology for storage of information such as computer readable instructions, data structures, program modules or other data. Communication medium may include computer readable instructions, data structures, and other data in non-transitory data signals, such as program modules.

Those of ordinary skill in the art related to this embodiment understand that it may be implemented in a modified form without departing from the scope of the disclosure. Therefore, the embodiments of the disclosure should be considered as illustrative examples only, and should not be construed as limiting the scope of the disclosure. The scope of the present disclosure is described in the claims rather than the foregoing description, and any modifications, substitutions and improvements of the embodiments of the disclosure should be construed as being included in the present disclosure.

1. A vaporizer comprising:
a storage unit configured to store an aerosol-generating material;
a wick configured to absorb the aerosol-generating material;
a heating element configured to heat the aerosol-generating material absorbed in the wick; and
an accommodating unit configured to accommodate the wick, and including a support groove for supporting the wick and a storage groove for temporarily storing the aerosol-generating material to deliver the aerosol-generating material to the wick,
wherein a maximum width of the storage groove is greater than a maximum width of the support groove.

2. The vaporizer of claim 1, wherein the storage groove includes a first region extending in a longitudinal direction of the wick from an end portion of the wick and a second region extending in a width direction along a width axis crossing the longitudinal direction of the wick from the end portion of the wick.

3. The vaporizer of claim 2, wherein the second region extends from the end portion of the wick to both directions along the width axis.

4. The vaporizer of claim 2, wherein the second region extends from the end portion of the wick to one direction along the width axis.

5. The vaporizer of claim 1, wherein the storage groove has a width that becomes smaller toward a direction away from the storage unit.

6. The vaporizer of claim 1, further comprising a sealing unit coupled to the storage unit, and having an opening through which the aerosol-generating material moves from the storage unit to the storage groove, wherein the opening is positioned to correspond to the storage groove when the sealing unit and the accommodating unit are coupled.

7. The vaporizer of claim 1, further comprising a sealing unit coupled to the storage unit, and having an opening through which the aerosol-generating material moves from the storage unit to the storage groove, wherein the maximum width of the storage groove is equal to or greater than a maximum width of the opening.

8. The vaporizer of claim 1, further comprising a sealing unit coupled to the storage unit, and having an opening through which the aerosol-generating material moves from the storage unit to the storage groove, wherein the accommodating unit and the sealing unit forms a cavity, and at least a portion of the wick is disposed in the cavity.

9. The vaporizer of claim 8, wherein the sealing unit is in contact with the wick such that the sealing unit and the support groove surround at least a portion of the wick.

10. The vaporizer of claim 8, wherein the sealing unit further has an extension surface connected to the opening and inclined toward the wick.

11. The vaporizer of claim 8, wherein
the wick includes a first end portion, a second end portion, and a central portion between the first end portion and the second end portion, and the central portion of the wick and the heating element are disposed in the cavity.

12. The vaporizer of claim 8, wherein the accommodating unit includes an inlet through which outside air is introduced and an outlet through which an aerosol generated in the cavity is discharged.

13. The vaporizer of claim 1, wherein the wick is in contact with an inner surface of the storage groove.

14. An aerosol-generating device comprising:
a vaporizer according to claim 1; and
a processor configured to control power supplied to the heating element of the vaporizer.

15. The aerosol-generating device of claim 14, further comprising:
a housing including a space in which an aerosol-generating article is accommodated; and
a heater configured to heat the aerosol-generating article accommodated in the housing.
